(19) United States
(12) Patent Application Publication
(10) Pub. No.: US 2006/0258785 A1
(43) Pub. Date: Nov. 16, 2006

(54) Process for production of alkyl and aryl carbamates

(75) Inventors: Srinivas Darbha, Pune (IN); Srivastava Rajendra, Pune (IN); Ratnasamy Paul, Pune (IN)

Correspondence Address: LADAS & PARRY, 26 WEST 61ST STREET, NEW YORK, NY, 10023, US

(73) Assignee: COUNCIL OF SCIENTIFIC AND INDUSTRIAL RESEARCH

(21) Appl. No.: 11/396,241

(22) Filed: Mar. 31, 2006

(30) Foreign Application Priority Data
Mar. 31, 2005 (IN) 0769/DEL/2005

(51) Int. Cl. C08K 5/34

(52) U.S. Cl. 524/100

(57) ABSTRACT

The present invention relates to an efficient process for the production of alkyl and aryl carbamates of the formula, RR′N—C(O)—OR″, wherein the said process comprises reacting an amine with carbon dioxide and organic halide compound in a solvent medium (use of which is optional), in the presence of a solid metal-containing catalyst, at a pressure of 1-15 bar and temperature between 0 to 180° C., for 0.5 to 5 hrs, separating the catalyst and recovering the corresponding carbamate formed by conventional methods; R, R′ and R″ are each selected independently from the group consisting of H, alkyl having 1-12 carbon atoms and aryl.

### FIELD OF THE INVENTION

The present invention relates to an efficient process for the production of alkyl and aryl carbamates comprising contacting an amine with carbon dioxide and organic halide compound in the presence of a solid catalyst, in a solvent medium use of which is optional. More particularly, the present invention relates to an eco-friendly, non-toxic, phosgene-/isocyanate-/CO-free clean process. Still more particularly, it deals with an improved process wherein the reaction is carried out at mild conditions avoiding use of additional co-catalysts/promoters such as onium salts.

### BACKGROUND OF THE INVENTION

Carbamates with —OCONH— structural unit are important raw materials for the manufacture of a variety of polymers (e.g., polyurethanes) used in foams, coatings, adhesives, plastics and fibers. They are also used as herbicides, fungicides and pesticides in agrochemical industry (e.g., CARBARYL, CARBOFURAN, PROPOXUR, DIOXACARB, AMINOCARB etc.) and drug intermediates in pharmaceutical industry (e.g., secondary amyl carbamate, trichloroethyl carbamate, physostigmine, carbachol etc.).

Carbamates have been manufactured by phosgene/isocyanate technology wherein aromatic or aliphatic amines are reacted with phosgene to produce isocyanates which are then reacted with alcohol to yield the corresponding carbamates. This process using phosgene and isocyanate is highly toxic and hence, unsafe. Another incentive to eliminate phosgene is the economic penalty incurred because the chlorine content of phosgene is wasted and converted into NaCl. Caustic soda is consumed in the conversion and the disposal of waste salt solutions presents ecological problems in itself.

Production of carbamates by reductive carbonylation route using Pt group metal catalysts is another alternative but it is economically not viable; only one-third of CO could be utilized effectively and the separation of CO and CO₂ increases the operation cost.

U.S. Pat. Nos. 4,304,922; 4,297,560; 5,194,660 and 5,502,241 describe oxidative carbonylation route. High yields of carbamates were achieved by this route. But this route is also hazardous as it involves handling of CO+O₂ mixtures at harsh conditions (50-400 bar; 443 K). Eco-friendly routes for the preparation of carbamates are highly desirable.

Methoxycarbonylation of amines using dimethyl carbonate (DMC) as methoxylating agent was proposed as a phosgene-free route (Tetrahedron Letters Year 1986, Vol. 27 page 5521). However, separation of methanol-DMC azeotrope is an expensive operation in this process.

Carbamates can also be synthesized by the Hoffmann rearrangement of amides, reaction of chloroformates and amines etc (Tetrahedron Letters Year 1997, Vol. 38, 8878; Year 1998, Vol. 39, 3259).

Among several phosgene-/isocyanate-free alternative routes, reaction of primary amines with CO₂ and organic halide is the most promising high yielding route (J. Chem. Soc. Chem. Commun. Year 1994, page. 699; Tetrahedron Year 1992, vol. 48, page 1515; U.S. Pat. Nos. 6,528,678; 6,399,808). In addition to the advantageous feature of not being hazardous, the synthetic route contributes to the issue of utilization of “greenhouse effect gas” CO₂ and environmental-clean-up. Generally strong organic bases, crown ethers and onium salts in homogeneous phase stabilize the carbamate anion and catalyze the synthesis of carbamates (Chem. Rev. 2004; J. Org. Chem. Year 1995, vol. 60, 2820). There have been reports on the use of ionic liquids and solids like CsCO₃ and K₂CO₃ for this reaction as catalysts (Tetrahedron Year 2002, Vol. 58, page 3329; J. Org. Chem. Year 2001; Vol. 66, page. 1035; Organic Letters Year 2000, Vol. 2, page 2797). However, due to their low activity very large amounts of such catalysts (almost equal to the quantity of the substrate) had to be used at long reaction times. Moreover these catalysts require large amounts of quaternary ammonium salt promoters to enhance carbamation while suppressing N-alkylation (U.S. Pat. No. 6,399,808). Other reports that deal with the synthesis of organic carbamates include U.S. Pat. Nos. 6,566,533; 5,666,988; 4,156,784 and 4,415,745.

### OBJECTS OF THE INVENTION

One object of the present invention to provide an improved process for the preparation of alkyl and aryl carbamates having high conversion and high yields.

Another object is to provide a process for production of carbamates wherein use of toxic phosgene, isocyanate and CO is eliminated by reacting amines with carbon dioxide and organic halide in the presence of solid zeolite-based catalysts.

### SUMMARY OF THE INVENTION

The present invention is an environmental-friendly green process carried out in the presence of a solid catalyst at low temperatures and CO₂ pressures. The catalyst could be separated easily by simple filtration and reused. Most importantly, the catalyst is highly efficient and only a small amount of it is needed unlike the prior art solid catalysts. The present invention utilizes a metallosilicate or a zeolite-encapsulating and/or entrapping organometallic complex comprising N and O-donor atoms in its cages/cavities. The solid catalyst could also be an aluminophosphate.

### DETAILED DESCRIPTION OF THE INVENTION

It is a surprising discovery that the solid zeolite-based catalyst exhibits superior activity with high carbamate selectivity. The process is atom-efficient. Molecular isolation, zeolite-metal interactions and the fine-tuned redox properties are the possible causes for the superior activity of the catalysts of present invention for this reaction.

In the investigations leading to the present invention, it was found that when active centers or metal ions are isolated and substituted in the framework (for example in the in the case of metallosilicates) or encapsulated in the pores of zeolite, the activity is enhanced. The prior art catalysts are not sufficiently active as the catalysts of the present invention. These novel zeolite-based catalysts could be easily separated from the reaction products by simple filtration process, thereby avoids the tedious process of catalyst recovery characteristic of prior art processes. Hence the present invention is environmentally more beneficial. The present invention does not involve the toxic phosgene reactants and hence, unlike the commercial process it is safer. Unlike the prior art catalysts, the reaction using the catalysts of present invention could be carried out without use of any promoters.

The present invention provides an efficient process for the production of alkyl and aryl carbamates of formula, RR′N—C(O)—OR″, wherein the said process comprises reacting an amine with carbon dioxide and organic halide compound in the presence of a solid metal-containing catalyst at a pressure of 1-15 bar and temperature between 0 to 180° C. for 0.5 to 5 hrs separating the catalyst and recovering the corresponding carbamate formed by conventional methods; R, R′ and R″ are each selected independently from the group consisting of H, alkyl having 1-12 carbon atoms and aryl. The reaction may also be carried out in a solvent use of which is optional.

The solid catalyst is a zeolite such as aluminosilicate having a molecular formula Mⁿ⁺_{x/n} [(AlO₂⁻)ₓ(SiO₂)_{y}].z H₂O where n is the valance of the charge corresponding cation M like sodium, potassium, cesium etc.; x assume value between 0 to 0.5. The ratio of x/y is less than or equal to 1, or a zeolite containing an encapsulated organometallic complex having formula C₃₂H₁₆N₈M where M=Al, Cu, Co or Ni. The solid catalyst metallosilicate, for example, has a composition TiₓSi₁₋ₓO₂ where x=0 to 0.04. The metal complex consists of transition metal ions such as Al, Cu, Co and Ni and coordinated ligands containing N— and/or O-donor atoms such as phthalocyanines, porphyrins, Schiff bases, peraza macrocycles, pyridine or its derivatives.

The amine can be a primary amine containing alkyl having 1-12 carbon atoms and aryl group.

The organic halide consists of 1-12 carbon atoms and preferably n-butyl bromide or n-butyl chloride. The solvent may be a polar or non-polar exemplified by methanol, acetonitrile and N,N′-dimethyl formamide. Use of solvent is optional as the reaction could be carried out even in the absence of any solvent.

The ratio of amine to organic halide is preferably 1 to 6. High yields of the carbamate could be achieved without any additional co-catalyst or promoters. In another embodiment the ratio of substrate amine to catalyst could be as high as 40-50.

The process of the present invention that it is phosgene-/isocyanate-/CO-free and hence, more environmental-friendly. The reaction can be carried out even in the absence of a solvent, a co-catalyst or promoter. The solid catalyst is easily separable by simple filtration and could be reused with little loss in activity. In yet another feature, the selectivity for the carbamate is about 85%.

This process of the invention is described below with reference to examples which are illustrative and should not be construed as limiting the present invention.

### EXAMPLE 1

Copper phthalocyanine encapsulated in zeolite-Y (CuPc-Y) was prepared according to the procedure of Seelan et al (J. Mol. Catal. A: Chemical Vol. 157, Year 2000, pages 163-171). Copper exchanged Y (Cu—Y) was prepared first by ion exchanging zeolite NaY (5 g) with an aqueous solution of Cu(NO₃)₂.2.5H₂O (250 mg in 100 ml distilled water). In the preparation of zeolite-Y-encapsulated copper phthalocyanine, 3 gm of Cu—Y was degassed for 8 h at 373 K in vacuum and then exposed to the vapors of 1,2-dicyanobenzene (10 g) at 533 K for 24 h. Nitrogen was used as a carrier gas. The solid was Soxhlet extracted with different solvents viz., acetone, pyridine, acetonitrile. The sample CuPc-Y, thus obtained was finally dried at 373 K.

### EXAMPLE 2

This example illustrates the preparation of cobalt phthalocyanine encapsulated in zeolite-Y (CoPc-Y). Cobalt exchanged Y (Co—Y) was prepared first by ion exchanging zeolite NaY (5 g) with an aqueous solution of Co(CH₃COO)₂.4H₂O (250 mg in 100 ml distilled water). In the preparation of zeolite-Y-encapsulated cobalt phthalocyanine, 3 gm of Co—Y was degassed for 8 h at 373 K in vacuum and then exposed to the vapors of 1,2-dicyanobenzene (10 g) at 533 K for 24 h. Nitrogen was used as a carrier gas. The solid was Soxhlet extracted with different solvents viz., acetone, pyridine, acetonitrile. The sample CoPc-Y, thus obtained was finally dried at 373 K.

### EXAMPLE 3

This example illustrates the preparation of nickel phthalocyanine encapsulated in zeolite-Y (NiPc-Y). Nickel exchanged Y (Ni—Y) was prepared first by ion exchanging zeolite NaY (5 g) with an aqueous solution of Ni(CH₃COO)₂.4H₂O (250 mg in 100 ml distilled water). In the preparation of zeolite-Y-encapsulated nickel phthalocyanine, 3 gm of Ni—Y was degassed for 8 h at 373 K in vacuum and then exposed to the vapors of 1,2-dicyanobenzene (10 g) at 533 K for 24 h. Nitrogen was used as a carrier gas. The solid was Soxhlet extracted with different solvents viz., acetone, pyridine, acetonitrile. The sample NiPc-Y, thus obtained was finally dried at 373 K.

### EXAMPLE 4

N,N-o-phenylenebis(salicylidenaminato) copper(II) encapsulated in zeolite-Y (CuSaloph-Y) was prepared according to the published procedure of Bennur et al (Microporous Mesoporous Mater. Vol. 48, Year 2001, pages 111-118). Copper exchanged Y (Cu—Y) was prepared first by ion exchanging zeolite NaY (5 g) with an aqueous solution of Cu(NO₃)₂.2.5H₂O (250 mg in 100 ml distilled water). In the preparation of zeolite-Y-encapsulated CuSaloph, 3 gm of Cu—Y was degassed for 8 h at 373 K in vacuum and then exposed to the vapors of Saloph ligand (10 g) at 473 K for 24 h. Nitrogen was used as a carrier gas. The solid was Soxhlet extracted with different solvents viz., acetone, pyridine, acetonitrile. The sample CuSaloph-Y, thus obtained was finally dried at 373 K.

### EXAMPLE 5

Titanium silicalite-1 (TS-1) was prepared according to the published procedure of Thangaraj et al (J. Catal. 130, 1 (1991)). Si/Ti ratio of the catalyst is 33 and the catalyst has specific surface area of 400 m²/g. The general procedure for the preparation of TS-1 is as follows: To a solution of tetraethyl orthosilictae (TEOS), in isopropyl alcohol, the appropriate amount of aqueous tetrapropyl ammonium hydroxide (20% aq. TPAOH solution) was added to partially hydrolyze the TEOS. To this resulting liquid mixture a required quantity of titanium tetrabutoxide [Ti(OBu)₄], in dry isopropyl alcohol was added drop wise under vigorous stirring. The clear liquid was stirred for about 1 h in order to complete the hydrolysis of TEOS and Ti(OBu)₄. Finally the solution of remaining TPAOH in doubled distilled water was added slowly to reaction mixture. This final mixture was stirred at 348-353 K for about 6 h to remove the alcohol. The crystallization was done at statically at 443 K for 4 days. The crystalline solid was filtered, washed dried and calcined at 823 K for 10 h.

### EXAMPLE 6

This example (Run No. 1) reports the preparation of butyl-N-phenyl carbamate in the absence of a solvent. The product is prepared from aniline, n-butyl bromide and CO₂ over TS-1 catalyst. In a typical reaction, 2 mmol of aniline 6 mmol of n-butyl bromide and 100 mg of TS-1 were charged into a 300 ml stainless steel Parr autoclave. The reactor was then pressurized with CO₂ (3.4 bar). Temperature was raised to 353 K and reactions were conducted for 3 h. The reactor was then cooled to 298 K and unutilized CO₂ was vented out. The catalyst was recovered from the reaction mixture by filtration. The filtrate was poured into water (30 ml) and extracted with ethyl acetate (30 ml, 3 times). The organic layer was washed with water (30 ml, 2 times) and brine (30 ml) and dried over anhydrous sodium sulfate. The solvent was evaporated. The products were analyzed by thin layer chromatography (TLC) and gas chromatography (Shimadzu 14B GC; SE-52 packed column (6-feet long×1.25-mm i.d.)). They were characterized and identified by GC-MS (Shimadzu QP-5000 (30-m long×0.25-mm i.d.)), FT-IR (Shimadzu 8201 PC spectrophotometer) and ¹H NMR (Bruker AC 200) spectroscopies. Mass balances were >98%.

### EXAMPLE 7

This example (Run No. 2) reports the preparation of butyl-N-phenyl carbamate in the absence of a solvent using a catalyst copper phthalocyanine encapsulated in zeolite-Y (CuPc-Y). The product is prepared from aniline, n-butyl bromide and CO₂. In a typical reaction, 2 mmol of aniline 6 mmol of n-butyl bromide and 83 mg of CuPc-Y were charged into a 300 ml stainless steel Parr autoclave. The reactor was then pressurized with CO₂ (3.4 bar). Temperature was raised to 353 K and reactions were conducted for 3 h. The reactor was then cooled to 298 K and unutilized CO₂ was vented out. The catalyst was recovered from the reaction mixture by filtration. Product was isolated and identified as described in Example 6.

### EXAMPLE 8

This example (Run No. 3) reports the preparation of butyl-N-phenyl carbamate in the presence of N,N-dimethylformamide (DMF) solvent. The product is prepared from aniline, n-butyl bromide and CO₂ over TS-1 catalyst. In a typical reaction, 2 mmol of aniline, 6 mmol of n-butyl bromide, 10 g of DMF and 100 mg of TS-1 were charged into a 300 ml stainless steel Parr autoclave. The reactor was then pressurized with CO₂ (3.4 bar). Temperature was raised to 353 K and reactions were conducted for 3 h. The reactor was then cooled to 298 K and unutilized CO₂ was vented out. Catalyst was recovered from reaction mixture by filtration. Products were isolated and identified as detailed in Example 6.

### EXAMPLE 9

This example (Run No. 4) reports the preparation of butyl-N-phenyl carbamate in the presence of DMF solvent using CuPc-Y catalyst. The product is prepared from aniline, n-butyl bromide and CO₂. In a typical reaction, 2 mmol of aniline 6 mmol of n-butyl bromide, 10 g of DMF and 83 mg of CuPc-Y were charged into a 300 ml stainless steel Parr autoclave. The reactor was then pressurized with CO₂ (3.4 bar). Temperature was raised to 353 K and reactions were conducted for 3 h. The reactor was then cooled to 298 K and unutilized CO₂ was vented out. The catalyst was recovered from the reaction mixture by filtration. Product was isolated and identified as described in Example 6.

### EXAMPLE 10

This example (Run No. 5) reports the preparation of butyl-N-phenyl carbamate in the presence of DMF solvent using CoPc-Y catalyst. The product is prepared from aniline, n-butyl bromide and CO₂. In a typical reaction, 2 mmol of aniline 6 mmol of n-butyl bromide, 10 g of DMF and 83 mg of CoPc-Y were charged into a 300 ml stainless steel Parr autoclave. The reactor was then pressurized with CO₂ (3.4 bar). Temperature was raised to 353 K and reactions were conducted for 3 h. The reactor was then cooled to 298 K and unutilized CO₂ was vented out. The catalyst was recovered from the reaction mixture by filtration. Product was isolated and identified as described in Example 6.

### EXAMPLE 11

This example (Run Nos. 6 and 7) reports the reusability of catalyst CoPc-Y in successive reactions in of preparation of butyl-N-phenyl carbamate. Catalyst recovered in Example 11 is reused in this example. In a typical reaction, 2 mmol of aniline 6 mmol of n-butyl bromide, 10 g of DMF and 83 mg of used CoPc-Y were charged into a 300 ml stainless steel Parr autoclave. The reactions were performed as described in Example 10. Products were isolated and identified as described in Example 6. The catalyst was reused 2^{nd} time performing the reaction as described above.

### EXAMPLE 12

This example (Run No. 8) reports the preparation of butyl-N-phenyl carbamate in the presence of DMF solvent using NiPc-Y catalyst. The product is prepared from aniline, n-butyl bromide and CO₂. In a typical reaction, 2 mmol of aniline 6 mmol of n-butyl bromide, 10 g of DMF and 83 mg of NiPc-Y were charged into a 300 ml stainless steel Parr autoclave. The reactor was then pressurized with CO₂ (3.4 bar). Temperature was raised to 353 K and reactions were conducted for 3 h. The reactor was then cooled to 298 K and unutilized CO₂ was vented out. The catalyst was recovered from the reaction mixture by filtration. Product was isolated and identified as described in Example 6.

Catalytic activities of different catalysts described in Examples 6-12 are listed in Table 1.

The versatility of TS-1 catalysts in the preparation for carbamates from different types of amines are described in the following examples.

### EXAMPLE 13

This example (Runs A and B) reports the preparation of butyl-N-hexyl carbamate from n-hexylamine, n-butyl halide and CO₂ over TS-1 catalyst. In a typical reaction, 2 mmol of n-hexylamine, 1 mmol of n-butyl bromide or n-butyl chloride, 10 g of DMF and 100 mg of TS-1 were charged into a 300 ml stainless steel Parr autoclave. The reactor was then pressurized with CO₂ (3.4 bar). Temperature was raised to 353 K and reactions were conducted for 3 h. Products were isolated and identified as detailed in Example 6.

### EXAMPLE 14

This example (Runs C and D) reports the preparation of butyl-N-dodecyl carbamate from n-dodecylamine, n-butyl halide and CO₂ over TS-1 catalyst. In a typical reaction, 2 mmol of n-dodecylamine, 1 mmol of n-butyl bromide or n-butyl chloride, 10 g of DMF and 100 mg of TS-1 were charged into a 300 ml stainless steel Parr autoclave. The reactor was then pressurized with CO₂ (3.4 bar). Temperature was raised to 353 K and reactions were conducted for 3 h. Products were isolated and identified as detailed in Example 6.

### EXAMPLE 15

This example (Runs E & F) reports the preparation of butyl-N-cyclohexyl carbamate from cyclohexylamine, n-butyl halide and CO₂ over TS-1 catalyst. In a typical reaction, 2 mmol of n-cyclohexylamine, 1 mmol of n-butyl bromide or n-butyl chloride, 10 g of DMF and 100 mg of TS-1 were charged into a 300 ml stainless steel Parr autoclave. The reactor was then pressurized with CO₂ (3.4 bar). Temperature was raised to 353 K and reactions were conducted for 3 h. Products were isolated and identified as detailed in Example 6.

### EXAMPLE 16

This example (Runs G and H) reports the preparation of butyl-N-benzyl carbamate from benzylamine, n-butyl halide and CO₂ over TS-1 catalyst. In a typical reaction, 2 mmol of n-hexylamine, 1 mmol of n-butyl bromide or n-butyl chloride, 10 g of DMF and 100 mg of TS-1 were charged into a 300 ml stainless steel Parr autoclave. The reactor was then pressurized with CO₂ (3.4 bar). Temperature was raised to 353 K and reactions were conducted for 3 h. Products were isolated and identified as detailed in Example 6.

### EXAMPLE 17

This example (Run I) reports the preparation of butyl-N-2,4,6-trimethylaniline carbamate from 2,4,6-trimethylaniline, n-butyl halide and CO₂ over TS-1 catalyst. In a typical reaction, 2 mmol of n-2,4,6-trimethylaniline, 1 mmol of n-butyl bromide or n-butyl chloride, 10 g of DMF and 100 mg of TS-1 were charged into a 300 ml stainless steel Parr autoclave. The reactor was then pressurized with CO₂ (3.4 bar). Temperature was raised to 353 K and reactions were conducted for 3 h. Products were isolated and identified as detailed in Example 6.

The catalytic activity data for the preparation of different carbamates over zeolite-based solid titanosilicate catalysts described by Examples 13-17 are listed in TABLE 2.

TABLE 1
Preparation of Butyl-N-phenyl Carbamate from aniline, CO₂ and
n-butylbromide over zeolite-based solid catalysts

| | | | Con- | Product selectivity (wt %) | |
|---|---|---|---|---|---|
| Run | | | version | Butyl-N-phenyl | N,N- |
| No. | Catalyst | Solvent | (wt %) | carbamate | Dibutylaniline |
| 1 | TS-1 | No solvent | 89.4 | 36.0 | 64.0 |
| 2 | CuPc-Y | No solvent | 99.1 | 41.4 | 58.6 |
| 3 | TS-1 | DMF | 95.8 | 59.4 | 40.6 |
| 4 | CuPc-Y | DMF | 93.6 | 80.0 | 20.0 |
| 5 | CoPc-Y | DMF | 89.2 | 74.8 | 25.2 |
| 6 | CoPc-Y | DMF | 91.5 | 70.2 | 29.8 |
| | (recycle 1) | | | | |
| 7 | CoPc-Y | DMF | 92.9 | 69.8 | 30.2 |
| | (recycle 2) | | | | |
| 8 | NiPc-Y | DMF | 83.3 | 78.7 | 21.3 |

TABLE 2
Catalytic activity data for carbamate synthesis
over titanosilicate (TS-1) catalyst

| | | | | % Product selectivity | | |
|---|---|---|---|---|---|---|
| | | | Amine | | N- | |
| Run | | Alkyl | conversion | | Alkylated | Carbamate |
| No. | Amine | halide | (wt %) | Carbamate | product | yield % |
| A | n-Hexylamine | n-BuBr | 91.4 | 94.5 | 5.5 | 86.4 |
| B | | n-BuCl | 83.0 | 96.4 | 3.6 | 80.0 |
| C | n-Dodecylamine | n-BuBr | 92.8 | 96.5 | 3.5 | 89.5 |
| D | | n-BuCl | 78.4 | 95.2 | 4.8 | 74.6 |
| E | Cyclohexylamine | n-BuBr | 63.2 | 92.5 | 7.5 | 58.5 |
| F | | n-BuCl | 53.8 | 96.4 | 3.6 | 51.9 |
| G | Benzylamine | n-BuBr | 66.6 | 95.2 | 4.8 | 63.4 |
| H | | n-BuCl | 60.4 | 87.6 | 12.4 | 52.9 |
| I | 2,4,6-trimethylaniline | n-BuBr | 56.0 | 97.8 | 2.2 | 54.7 |

The process described above has the combined unique advantages of high conversion of amine accompanied with high selectivity for carbamate. The process is environmentally-friendly and does not involve toxic reactants like phosgene, isocyanate and CO. Little effort is required to separate the catalyst and the separated catalysts can be reused with no significant loss in activity. High selectivities for carbamate can be obtained without using any additional cocatalysts or promoters.

We claim:

1. A process for production of alkyl and aryl carbamates of formula, RR′N—C(O)—OR″, the process comprising reacting an amine with carbon dioxide and organic halide compound in the presence of a solid metal-containing catalyst, separating the catalyst and recovering the corresponding carbamate, wherein in the carbamate, R, R′ and R″ are each selected independently from the group consisting of H, alkyl having 1-12 carbon atoms and aryl.

2. A process as claimed in claim 1, wherein the solid metal catalyst is selected from the group consisting of titanosilicate, titanium-containing zeolite molecular sieve and a transition metal complex encapsulated/entrapped in zeolite cages/cavities.

3. A process as claimed in claim 2, wherein the transition metal complex consists of ligands containing N— and/or O-donor atoms selected from the group consisting of phthalocyanines, porphyrins, Schiff bases, peraza macrocycles and pyridine or derivatives thereof, and metal such as Cu, Ni, Co, Fe, and Cr.

4. A process as claimed in claim 1, wherein the reaction is carried out at a pressure of 1-15 bar.

5. A process as claimed in claim 1, wherein the reaction is carried out at a temperature between 0 to 180° C. for 0.5 to 5 hrs.

6. A process as claimed in claim 1, wherein the reaction is carried out in a solvent.

7. A process as claimed in claim 1, wherein the solid catalyst is an aluminosilicate having a molecular formula Mⁿ⁺_{x/n} [(AlO₂⁻)ₓ(SiO₂)_{y}].z H₂O wherein n is the valance of the charge corresponding cation M like sodium, potassium, cesium etc.; x is in the range of 0 to 0.5, and the ratio of x/y is less than or equal to 1.

8. A process as claimed in claim 1, wherein the solid catalyst is a zeolite containing an encapsulated organometallic complex having formula C₃₂H₁₆N₈M wherein, M=Al, Cu, Co or Ni.

9. A process as claimed in claim 1, wherein the solid catalyst is a metallosilicate with a composition TiₓSi₁₋ₓO₂ wherein, x=0 to 0.04.

10. A process as claimed in claim 8, wherein the metal complex consists of transition metal ions selected from the group consisting of Al, Cu, Co and Ni and coordinated ligands containing N— and/or O-donor atoms selected from the group consisting of phthalocyanines, porphyrins, Schiff bases, peraza macrocycles and pyridine or derivatives thereof.

11. A process as claimed in claim 1, wherein the amine is a primary amine containing alkyl having 1-12 carbon atoms and aryl group.

12. A process as claimed in claim 1, wherein the organic halide consists of 1-12 carbon atoms.

13. A process as claimed in claim 1, wherein the organic halide is selected from n-butyl bromide and n-butyl chloride.

14. A process as claimed in claim 6, wherein the solvent is a selected from a polar solvent and a non-polar solvent.

15. A process as claimed in claim 6, wherein the solvent is a selected from the group consisting of methanol, acetonitrile and N,N′-dimethyl formamide.

16. A process as claimed in claim 1, wherein the ratio of amine to organic halide is 1 to 6.

17. A process as claimed in claim 1, wherein the reaction is carried out in the absence of a co-catalyst and promoter.

18. A process as claimed in claim 1, wherein the ratio of amine to catalyst is in the range of 1:40-50.

19. A process as claimed in claim 1, wherein the reaction is phosgene-/isocyanate-/CO-free.

20. A process as claimed in claim 1, wherein the solid catalyst is separated by filtration and recycled.

21. A process as claimed in claim 1 wherein the selectivity for the carbamate is about 85%.
